(19) United States
(12) Patent Application Publication
(10) Pub. No.: US 2009/0020019 A1
(43) Pub. Date: Jan. 22, 2009

(54) FOOD COOKING DEVICE WITH COMBINATION VALVE

(76) Inventor: Medhavin P. Potdar, Fort Mill, SC (US)

Correspondence Address: THOMPSON HINE LLP;Intellectual Property Group, P.O Box 8801, DAYTON, OH, 45401-8801, US

(21) Appl. No.: 12/141,424

(22) Filed: Jun. 18, 2008

Related U.S. Application Data
(60) Provisional application No. 60/936,563, filed on Jun. 21, 2007.

(51) Int. Cl. A21B 3/00; F23Q 9/08

(52) U.S. Cl. 99/324; 431/280

(57) ABSTRACT

A burner system for a gas-burning cooking appliance includes an integrated valve which provides gas flow to both a pilot burner and a main burner. The integrated valve includes a main line valve to mechanically regulate the gas flow to the main burner, and a separate pilot line valve to mechanically regulate the gas flow to the pilot burner. The operations of the two valves are independent such that the operation of one valve does not regulate gas flow to the line controlled by the other valve.

### CROSS-REFERENCES

This application claims the benefit of U.S. provisional application Ser. No. 60/936,563, filed Jun. 21, 2007, the entirety of which is incorporated herein by reference.

### TECHNICAL FIELD

The application relates to a gas-burning cooking appliance, more particularly to a gas burner arrangement for a commercial cooking appliance involving a combination pilot and main burner valve structure.

### BACKGROUND

Gas-burning cooking appliances are typically lit by means of a pilot burner, which uses a small gas line supplied independently from the main fuel line. In a manually controlled system, a valve controls gas flow to the pilot burner. A separate valve controls gas flow to the main burner, often through the use of a valve stem.

Space and cost are at a premium in designing commercial cooking appliances. It would be advantageous to manufacture a gas-burning system using fewer components that can be assembled more quickly and at a reduced cost.

### SUMMARY

A cooking appliance uses a gas burner system that includes an integrated valve. The integrated valve combines the pilot line including the pilot valve with the main burner line including the main burner valve, while still allowing the valves to adjust flow to the lines independent of each other.

### BRIEF DESCRIPTION OF THE DRAWINGS

FIG. 1 shows a diagram describing the components of a prior art gas burner system for a cooking appliance.

FIG. 2 shows a diagram describing the components of a gas burner system including an integrated valve.

FIG. 3A is a side elevation view of an integrated valve.

FIG. 3B is the integrated valve of FIG. 3A viewed from above.

FIG. 3C is another side elevation view of an integrated valve.

FIG. 3D is the integrated valve of FIGS. 3A-3C viewed from below.

FIG. 4 is a cut-away from FIG. 3C showing the interior structure of the valve.

FIG. 5 is another embodiment of the valve.

FIG. 6 is a schematic depiction of a cooking device in the nature of a griddle apparatus with a cooking surface.

FIG. 7 is a schematic depiction of a cooking device in the nature of an oven apparatus with a cooking chamber.

### DETAILED DESCRIPTION

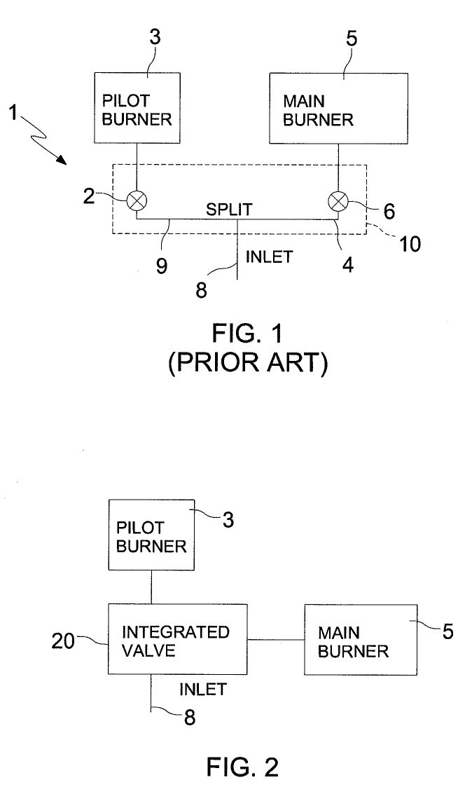

FIG. 1 shows a mechanical gas burner system 1 without an integrated valve. The pilot valve 2 controls gas flow to the pilot burner 3. The main burner line 4 controls gas flow to the main burner 5 through use of a valve 6, including a valve stem (not shown) which allows manual adjustment of the gas flow. In this system, the gas inlet 8 splits the gas flow to the pilot line 9 and the main burner line 4 upstream of the valves 2 and 6, which independently regulate gas flow to the burners 3 and 5.

As shown in FIG. 2, the integrated valve 20 is attached to the gas inlet and splits that gas flow into the pilot and main burner lines. This one component is a unified solution for fulfilling roles traditionally performed by several different components, as outlined by the dashed lines marked as 10 in FIG. 1.

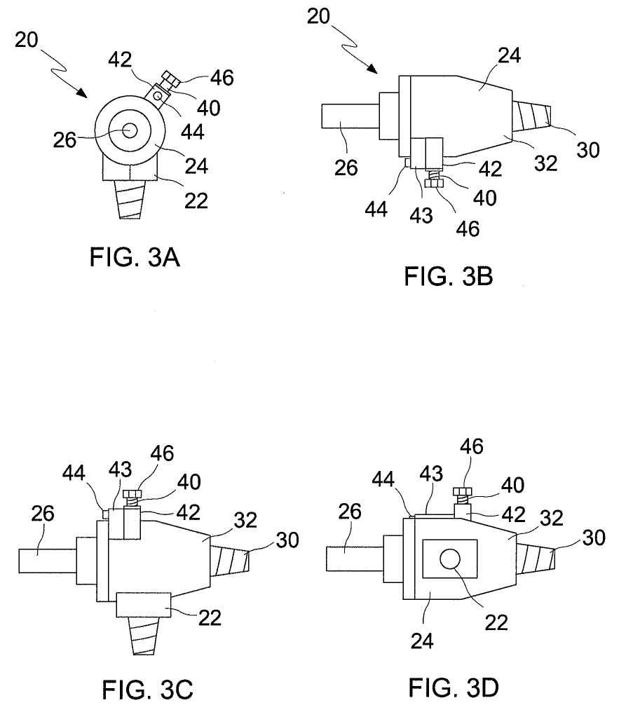

FIG. 3 shows an embodiment of the integrated valve 20 as viewed from different angles. Gas flows into the gas inlet 22 and into the main body 24. The main body 24 is in fluid communication with both the main burner line 30 and the pilot line 40. The main burner line 30 communicates with the main body 24 by means of the main burner outlet 32, which is disposed perpendicular to the gas inlet 22. Gas flow to the main burner line 30 is controlled by a valve stem 26 which extends from the main body in a direction opposite the main burner outlet 32 and perpendicular to the gas inlet 22 as shown. The valve stem 26 is configured to block or adjustably permit gas flow through the main burner outlet 32 (e.g., through manual rotation of the stem).

The pilot line 40 communicates with the main body 24 by means of a pilot outlet 42, which is disposed perpendicular to both the burner outlet 32 and valve stem 26 and at a 135 degree angle from the gas inlet 22. A pilot adjustment screw 44 is positioned in a body chamber 43 and can be used to regulate gas flow into the pilot line 40 by blocking or adjustably permitting gas flow through the pilot outlet 42 (e.g., through manual rotation of the pilot screw). The pilot line 40 may include additional regulation elements such as ferrel 46.

The gas inlet 22, main burner outlet 32, valve stem 26, pilot outlet 42 with pilot adjustment screw 44 sitting in body chamber 43, and main body 24 all exist as part of a single, integrated component. In the embodiment shown in FIG. 3, the gas inlet 22, main burner outlet 32, pilot outlet 42, body chamber 43, and main body 24 may be formed as a single metal or plastic part. By combining into one integrated component what would normally be represented by several separate components, the present gas valve system reduces the necessary manufacturing time and physical space associated with the construction of a gas burner.

The operation of the valve stem 26 does not block or permit gas flow with regard to the pilot outlet 42. The main body 24 is configured such that the pilot line 40 receives gas independent of the regulation of gas flow to the main burner line 30 by the valve stem 26. Thus, as in the multi-component system of FIG. 1, the gas flows to the pilot line and main burner line can be mechanically regulated independent of one another.

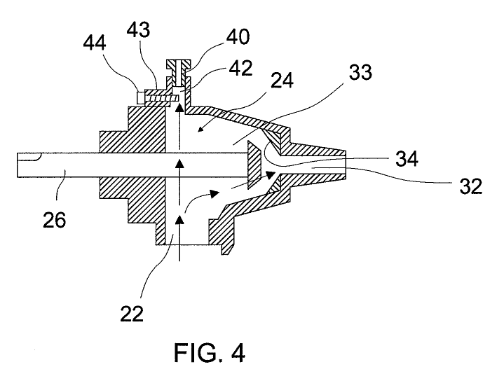

An example of an internal structure of the integrated valve is shown by FIG. 4. Within the main valve body 24 sits a valve stop 33, which is attached to the valve stem 26 in such a way that rotation of the valve stem 26 will move the valve stop 33 toward or away from the main burner line 30. As the valve stem 26 is operated to move the valve stop 33 toward the main burner line 30, eventually the valve stop 33 will come into contact with an annular ring seal or seat surface 34 which is affixed within the main burner outlet 32. The annular ring seal 34 is shaped to accommodate the valve stop 33, and is affixed to the periphery of the interior of the main burner outlet 32 in such a way that when the valve stop 33 is pressed against the annular ring seal 34, gas cannot flow from the main body 24 into the main gas line 30. Thus, the horizontal motion of the valve stop 33 via operation of the valve stem 26 acts as an adjustable valve to permit or block gas flow at the main burner outlet 32 into the main burner line 30.

As clearly shown in FIG. 3A, the main valve body 24 has a roughly circular cross section. The cylindrical valve stem 26 has a much smaller diameter than that of the main valve body 24. Therefore, the valve stem 26 does not impede the gas flow from the lower portion of the main body 24 at the gas inlet 22 to the upper portion of the main body 24 at the pilot outlet 42. Thus, operation of the valve stem 26 to seat or unseat the valve stop 33 relative to the annular ring seal 34 occurs downstream of the flow path from the gas inlet 22 to the pilot outlet 42, and has no appreciable effect on gas flow to the pilot outlet 42. Notably, the internal gas flow path of the main body is configured such that gas entering the body via the gas inlet 22 flows around, but in fluid contact with the valve stem 26 in order to reach the pilot outlet 42. The axial movement of the stem 26 does not alter the nature of the flow path from the inlet 22 to the outlet 42.

Returning to FIG. 4, the pilot adjustment screw 44 sits in the body chamber 43 and can be operated to increase or decrease the available area for gas to flow through the pilot outlet 42. Pilot adjustment screws of this type are well-known in the art. Other mechanisms for adjusting the flow of gas to the pilot may be part of the integrated valve in place of the pilot adjustment screw 44. In the operation of gas-burning appliances, it is typical to leave the pilot adjustment screw 44 in a position to allow gas flow through the pilot outlet 42 and into the pilot line 40, effectively leaving the pilot line open most of the time.

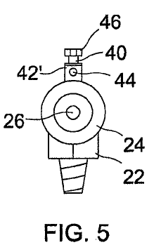

FIG. 5 shows an alternate embodiment of the integrated valve wherein the position of the pilot outlet 42′ is a full straight angle of 180 degrees from the gas inlet 22 rather than at an obtuse angle of 135 degrees as in FIGS. 2 and 3. The alternate placement of the pilot outlet 42′ is dictated by the available space and manufacturing parameters of the gas system, different configurations being suited in different cases to yield a more compact and efficient system. The alternate embodiment is functionally equivalent to that described above. Other variations in placement of components in the integrated valve are possible without departing from the scope of the invention.

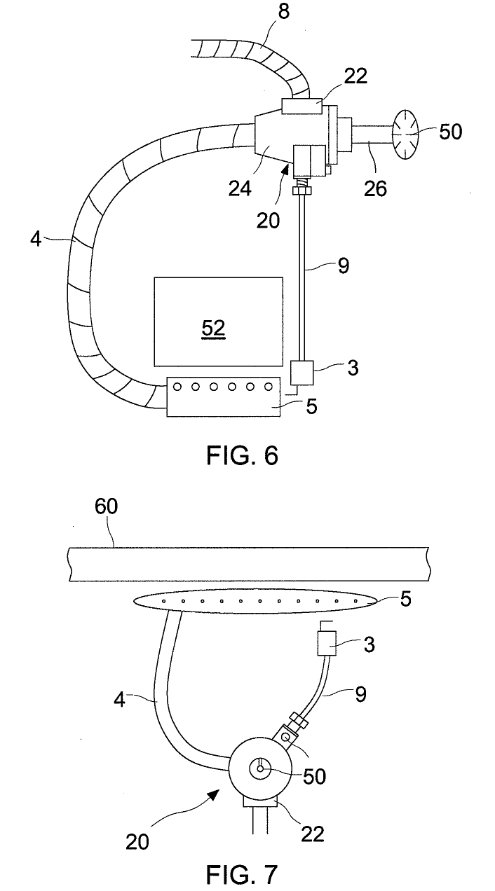

FIG. 6 shows an embodiment of the integrated valve incorporated in a commercial oven. Here, a dial or knob 50 facilitates rotation of the stem 26 to adjust the gas flow into the main burner line 4. The main burner 5, ignited by the pilot burner 3, is located underneath, or otherwise proximate to, the main oven cooking chamber 52. The burner 3 could be located in a combustion chamber located adjacent the cooking chamber 52, with a fan or other blower positioned to blow air past a heat exchange structure associated with the combustion chamber and into the cooking chamber 52.

FIG. 7 incorporates the integrated valve into a griddle instead. Here, the dial or knob 50 is located on the integrated valve 20 below the griddle surface 60 of a griddle plate. The dial or knob 50 again is manually rotated to operate the valve stem 26 to regulate gas flow to the main burner line 4 and the main burner itself 5. Turning the dial does not adjust the gas flow to the pilot line 9 or pilot burner 3. In an alternative embodiment, the surface 60 could be an open-top burner surface defined by one or more grate members that can support pots, pans etc. above the open flame of the burner.

The examples in FIGS. 6-7 are not limiting on the scope of the invention. Instead, the integrated valve has applications to wide a variety of gas-burning devices as understood by one skilled in the art.

1. A food cooking device, comprising:
a food cooking chamber or a food cooking surface;
a main burner positioned for heating the chamber or surface;
a pilot burner positioned for igniting the main burner;
a combination pilot and main burner valve, comprising:
a valve body having a gas inlet, a pilot outlet and a main burner outlet; and
a manual flow control for adjustably permitting gas flow from the gas inlet through the valve body to the main burner outlet, the manual flow control including a valve stem extending away from a valve seat near the main burner outlet and protruding from a front side of the valve body, and a gas flow path from the gas inlet to the pilot outlet extends past and in fluid contact with a portion of the valve stem that is upstream of the valve seat;
the main burner connected to receive gas from the main burner outlet of the valve body,
the pilot burner connected to receive gas from the pilot outlet of the valve body.

2. The combination valve of claim 1 wherein axial movement of the valve stem toward or away from the valve seat does not impact flow along the flow path from the gas inlet to the pilot outlet.

3. An integrated gas burner valve for a cooking device, the gas burner valve comprising:
a gas flow inlet;
a valve body;
a pilot line outlet;
a main burner line outlet;
a main burner adjustment valve for mechanical control of the flow of gas from the gas flow inlet to the main burner line outlet; and
a pilot adjustment for mechanical control of the flow of gas from the gas flow inlet to the pilot line outlet;
the valve body internally dividing the gas flow such that operation of the main burner adjustment valve does not control the flow of gas to the pilot line outlet and operation of the pilot adjustment does not control the flow of gas to the main burner line outlet;
wherein the gas flow inlet, valve body, pilot line outlet, and main burner line outlet are all portions of a single component.

4. The valve of claim 3, wherein the main burner adjustment valve comprises a valve stem that moves a valve stop relative to an annular ring seal at the main burner line outlet, such that seating the valve stop in the seal operates to block the gas flow through the main burner line outlet.

5. The valve of claim 3, wherein the pilot adjustment comprises a pilot screw positioned at the pilot outlet.

6. A food cooking device including a food cooking surface or chamber and a gas burner system arranged for heating the surface or chamber, the gas burner system comprising:
a main burner, a main burner line communicating with the main burner and providing gas flow to the main burner;
a pilot burner distinct from the main burner and positioned for igniting the main burner, a pilot line communicating with the pilot burner and providing gas flow to the pilot burner;
a gas inlet source communicating with both the main burner line and the pilot line to provide gas flow to both lines;
an integrated valve including
a gas flow inlet connected to the gas inlet source,
a pilot outlet connected to the pilot line, the pilot outlet further including a pilot adjustment operable to block the flow of gas to the pilot line without interrupting the flow of gas to the main burner line, and
a main burner outlet distinct from the pilot outlet and connected to the main burner line, the main burner outlet further including a main burner adjustment valve operable to block the flow of gas to the main burner line without interrupting the flow of gas to the pilot line;
wherein the integrated valve is formed as a single component.
